(19) United States
(12) Patent Application Publication
(10) Pub. No.: US 2026/0178358 A1
(43) Pub. Date: Jun. 25, 2026

(54) Enhanced Virtual Desktop Interaction Using Machine Learning

(71) Applicant: Citrix Systems, Inc., Fort Lauderdale, FL (US)

(72) Inventors: Mohanasundaram Shanmugam, Tamil Nadu (IN); Revathi Ayyadurai, Bengaluru (IN); Anil M. Kongovi, Bengaluru (IN); Santosh Sampath G C, Bangalore (IN)

(21) Appl. No.: 18/987,642

(22) Filed: Dec. 19, 2024

(51) Int. Cl. G06F 9/451; G06F 3/01; G06F 3/0484

(52) U.S. Cl. CPC G06F 9/452; G06F 3/013; G06F 3/0484; G06F 2203/04804

(57) ABSTRACT

A computing system may detect a user input. The computing system may capture, a screen buffer indicating a state of a user interface of a remote desktop session. The computing system may capture a screen buffer indicating a state of a user interface of the remote desktop session. The computing system may input the screen buffer into a model, to output user interface elements. The computing system may construct user interface element tree based on the hierarchical position of individual elements detected by the model. The computing system may identify a target UI element, and may identify, using a stored ruleset associated with the target element, an action to perform on the target element, and execute the action. The computing system may add transparent overlay on the screen or supply the user interface element position information to client operating system to enable accessibility and eye tracking based interaction.

### FIELD

Aspects described herein generally relate to computer networking, remote computer access, virtualization, enterprise mobility management, and hardware and software related thereto. More specifically, one or more aspects describe herein provide machine learning techniques to enhance virtual desktop interactions.

### BACKGROUND

In some instances, virtual desktops may be used with mobile devices, augmented/virtual reality devices, and/or other devices that are not designed for mouse pointer based interaction (e.g., such as traditional personal computers, desktops, or the like). Nevertheless, such mobile and mixed reality devices may use touch and/or virtual interaction (e.g., using eye tracking, gesture inputs, or the like) respectively. Due to this discrepancy, user interface (UI) element size, position, and/or accessibility may vary heavily between these devices, which may make it difficult for users to interact with virtual desktops (and their corresponding UI elements) on such devices.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards using machine learning techniques to enhance virtual desktop interactions.

In one or more instances, a computing system may include one or more processors and memory storing computer-readable instructions that, when executed by the one or more processors, cause the computing system to capture, a screen buffer indicating a state of a user interface of a remote desktop session. The computing system may query an object detection model using the screen buffer to identify user interface elements displayed on the user interface, and the object detection model may have been trained using computer generated images associated with sample user interfaces and corresponding user interface elements to identify, for a given input interface, a plurality of user interface elements. The computing system may construct, based on the identified user interface elements and their coordinates, a user interface tree hierarchy, where the user interface tree hierarchy may have been organized based on element position. The computing system may arrange at least a portion of the screen buffer based on one or more of: a frame delta, or a point of user interest. The computing system may detect, during the remote desktop session, a user input. The computing system may identify, based on information associated with the user input and using the user interface tree hierarchy, a target element of the user interface elements. The computing system may identify, using a stored ruleset associated with the target element, an action to perform on the target element. The computing system may execute, within the remote desktop session, the action on the target element.

In one or more instances, the object detection model may be a fine-tuned you only look once (YOLO) model to detect computer generated user interface elements. In one or more instances, the user input may include one or more of: a touch input, a gesture input, pencil input, stylus input, or input from an eye tracking sensor.

In one or more examples, the user interface tree hierarchy may indicate the coordinates, on the user interface, for each of the user interface elements, and the user interface elements are grouped based on parent child hierarchy. In one or more examples, the user interface elements includes a set of user interface elements on a taskbar, and wherein the set of user interface elements are grouped under taskbar.

In one or more instances, identifying the target element may include comparing the coordinates of the user interface elements in the user interface tree hierarchy with coordinates of the user input to identify which of the user interface elements is located nearest to a location of the user input. In one or more instances, the stored ruleset may indicate, for each of the user interface elements, one or more actions that may be triggered by selection of the target element.

In one or more examples, the stored ruleset may indicate a rules-based mapping between the user input and mouse inputs, where the mouse inputs include one of: a double click or a right click. In one or more examples, a client side virtual desktop application, executing at a user device, may maintain the object detection model.

In one or more instances, the computing system may collect feedback associated with execution of the action, and update, based on the feedback, one or more of: the object detection model or the stored ruleset. In one or more instances, identifying the target element using the user interface tree hierarchy may include initiating, using the user interface tree hierarchy, a transparent overlay for each identified user interface element.

In one or more examples, the user input may include an eye tracking signal, and the transparent overlay may be used to map the eye tracking signal to the target element. In one or more examples, the action may include magnifying the target element, expanding a selection area, dragging the target element or selecting text. In one or more examples, the point of user interest may be identified based on one or more of: the user input, a mouser pointer location, an eye focus, or portions of the user interface accessed more than a threshold amount of times.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIGS. 5A-5B depict an illustrative system architecture for using machine learning to enhance virtual desktop interaction in accordance with one or more illustrative aspects described herein.

FIGS. 6A-6B depict an illustrative event sequence for using machine learning to enhance virtual desktop interaction in accordance with one or more illustrative aspects described herein.

FIG. 7 depicts an illustrative method for using machine learning to enhance virtual desktop interaction in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards using machine learning to enhance virtual desktop experiences (e.g., by understanding the UI elements visible on the screen). For example, having knowledge on all the visible virtual desktop UI elements, their locations, and element types may help in improving the user interaction experience in various ways, such as accurately mapping the user touch coordinates to potential/nearby elements, providing interaction feedback, performing native highlighting overlay for text selection, intelligently mapping touch gesture inputs to mouse inputs based on underlying UI elements, and/or perform other actions.

For example, user interface elements such as buttons, icons, text, or the like designed for mouse pointer input may be relatively small as compared to elements designed for touch and virtual inputs. Users accessing virtual desktops in these thin devices may suffer from usability issues like inability to accurate touch on a particular UI element, perform text selection, invoke context menu, or the like.

Moreover, a lack of native interaction gestures like eye tracking, hand tracking, two finger tap, resize and rotation gestures, or the like may make it even more challenging to interact with virtual desktop UI elements. Similar problems may be noticed in touch screen virtual desktop clients where gestures like long press for a context menu or swipe gesture to minimize and maximize a window might not work.

For example, described below are several major problems identified in user interaction on mobile and mixed reality virtual desktop clients.

Imprecise touches: on touch based VDI clients, touch inputs may make it difficult for users to accurately tap the underlying user interface element, which may be difficult as the UI elements for desktop operating systems may be designed for mouse inputs.

Difficult spatial user interface interactions: difficulty in accessing virtual/remote desktop UI elements in spatial devices, such as those that make use of eye tracking to move the focus to an item and the finger taps to activate the focused element. While a native UI element may display a hover effect when focused using the eye, virtual/remote desktop UI elements within the session screen might not offer such user experiences, making it difficult to interact. Even the direct interaction using a finger/touch input may result in a poor user experience due to imprecise virtual touch.

Unusual gestures: touch gestures often vary between mobile native UI elements and virtual/remote desktop UI elements, making it hard for end users to interact. For example, a single tap on a native mobile UI element may activate the element, but a single tap on virtual/remote desktop UI elements may just highlight the element.

Challenging text interaction: it may be difficult to interact with text area like selection, scrolling and the context menu options cut, copy, and paste, using touch gestures.

Unreliable input area and input type detection: unreliable automatic soft keyboard launches when a text field is focused and a lack of detecting text field type like password fields to offer special features like disabled text predictions, local password manager access, or the like.

Deferred menu access: a right click menu event may be displayed for a few seconds without any feedback. This may cause the user to wonder if the right click event is performed or not. Also, bringing up the right click menu after text selection or within a text field may be very difficult.

Missing native accessibility: lack of native accessibility support across all of the virtual/remote desktop clients (desktop, mobile, spatial, or the like), as these clients might not have knowledge on the contents rendered on the screen.

Accordingly, to address these challenges, described herein is the use of an object detection machine learning model to identify UI elements present in a frame buffer rendered by a virtual desktop client. The knowledge of the UI element positions and their types may then be used to address the above mentioned issues and offer various enhancements.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

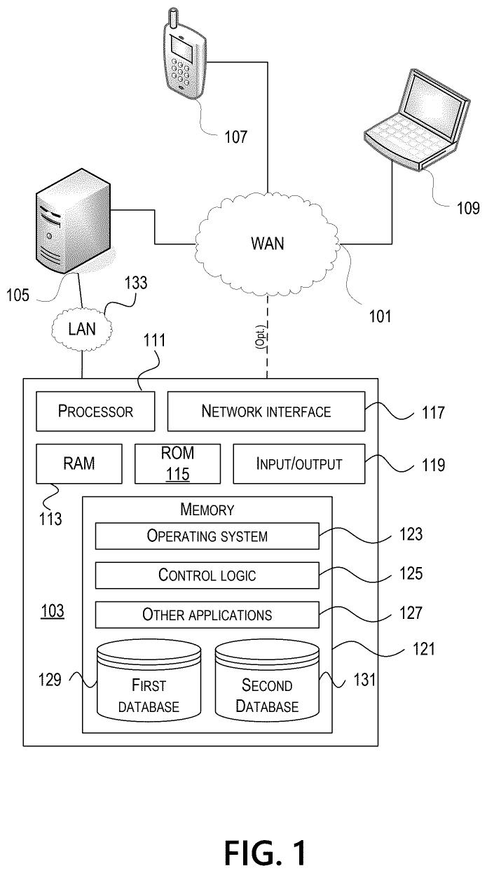

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity-which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

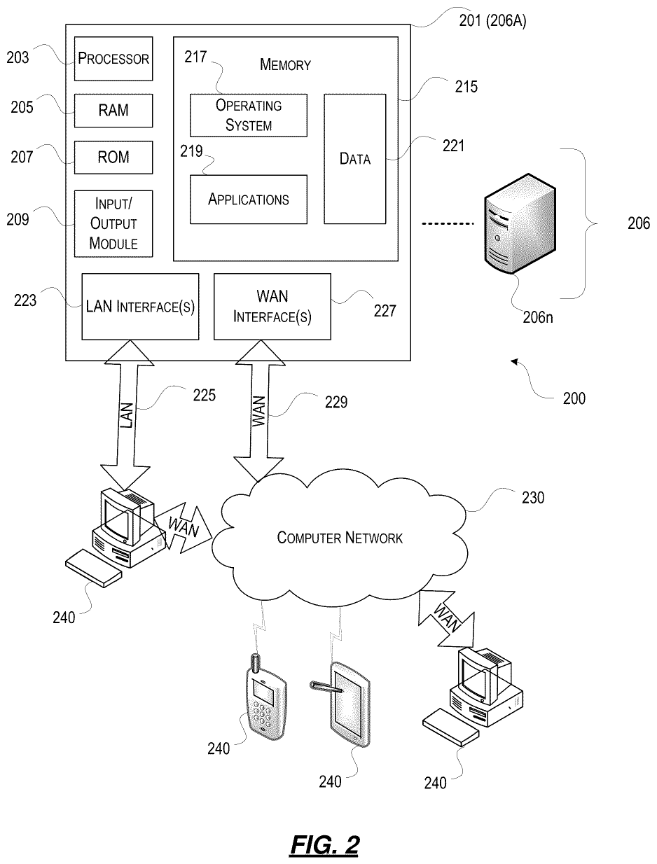

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

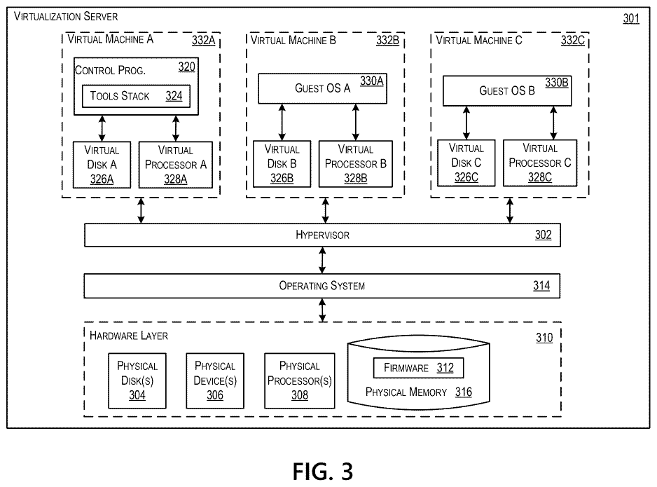

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

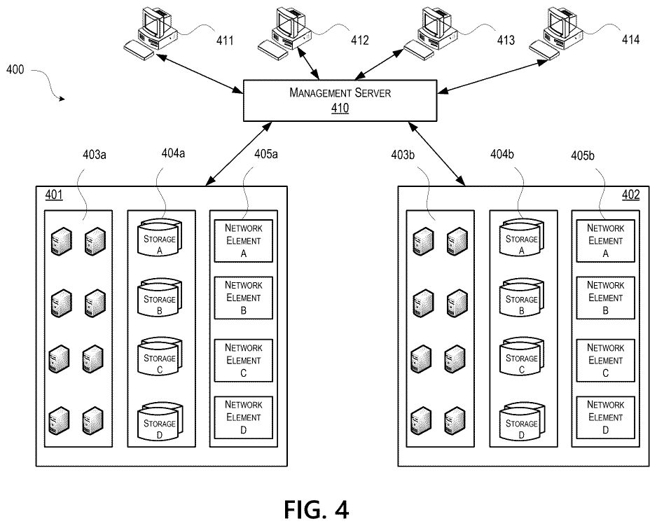

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Enhanced Virtual Desktop Interaction Using Machine Learning

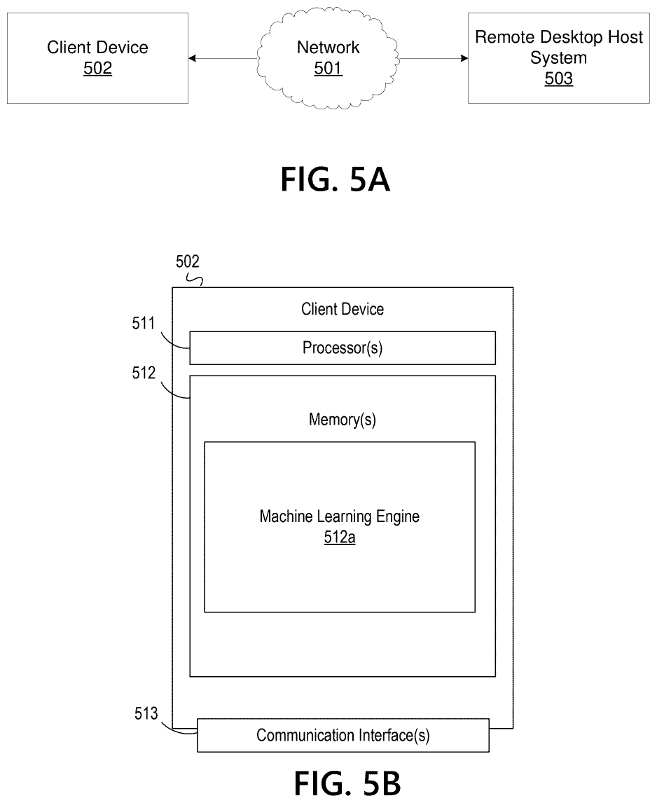

FIGS. 5A-5B depict an illustrative computing environment for using machine learning to enhance virtual desktop interaction in accordance with one or more example embodiments. Referring to FIG. 5A, computing environment may include one or more computer systems. For example, the computing environment may include a client device 502 and remote desktop host system 503.

As illustrated in greater detail below, client device 502 may be a personal computing device such as a smartphone, tablet, laptop computer, desktop computer, smart glasses, augmented reality (AR) device, virtual reality (VR) device, or the like. In some instances, client device 502 may be configured to facilitate remote desktop sessions. In some instances, the client device 502 may be configured to display graphical user interfaces, which may include remote/virtual desktop interfaces, or the like. In some instances, client device 502 may be configured with one or more eye tracking sensors. Although a single client device is depicted, any number of such devices may be implemented in the methods described herein without departing from the scope of the disclosure.

Remote desktop host system 503 may be a computer system that includes one or more computing devices (e.g., servers, server blades, or the like) and/or other computer components (e.g., processors, memories, communication interfaces). In one or more instances, remote desktop host system 503 may be configured to support the application and processing of one or more remote/virtual desktops, applications, or the like. In some instances, the remote desktop host system 503 may be configured to communicate with a client side virtual desktop application at the client device 502 to facilitate remote desktop sessions.

Computing environment 400 may also include one or more networks, which may interconnect client device 502 and remote desktop host system 503. For example, computing environment 400 may include a wired or wireless network 501 (which may e.g., client device 502 and remote desktop host system 503).

In one or more arrangements, client device 502, remote desktop host system 503, and/or the other systems included in the computing environment may be any type of computing device capable of receiving input via a user interface, and communicating the received input to one or more other computing devices. For example, client device 502, remote desktop host system 503, and/or the other systems included in the computing environment may in some instances, be and/or include server computers, desktop computers, laptop computers, tablet computers, smart phones, augmented reality (AR) devices, virtual reality (VR) devices, smart glasses, or the like that may include one or more processors, memories, communication interfaces, storage devices, sensor devices, and/or other components. As noted above, and as illustrated in greater detail below, any and/or all of client device 502, remote desktop host system 503 may, in some instances, be special purpose computing devices configured to perform specific functions.

Referring to FIG. 5B, client device 502 may include one or more processors 511, memory 512, and communication interface 513. A data bus may interconnect processor 511, memory 512, and communication interface 513. Communication interface 513 may be a network interface configured to support communication between the client device 502 and one or more networks (e.g., network 501, or the like). Memory 512 may include one or more program modules having instructions that when executed by processor 511 cause client device 502 to perform one or more functions described herein and/or access one or more databases that may store and/or otherwise maintain information which may be used by such program modules and/or processor 511. In some instances, the one or more program modules and/or databases may be stored by and/or maintained in different memory units of client device 502 and/or by different computing devices that may form and/or otherwise make up client device 502. For example, memory 512 may have, host, store, and/or include a machine learning engine 512a that may support the training, maintenance, and application of an object detection model for use in enhancing virtual desktop interactions.

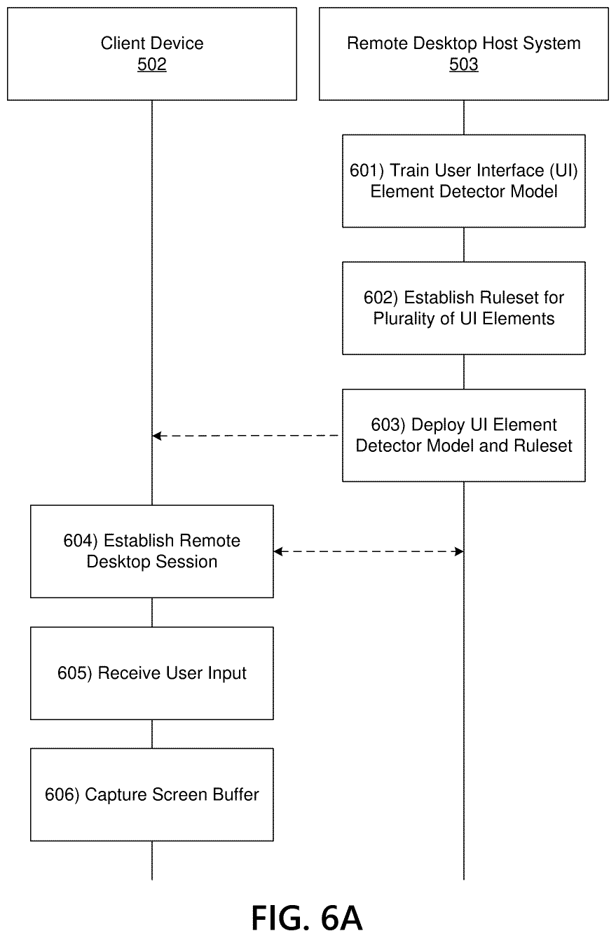

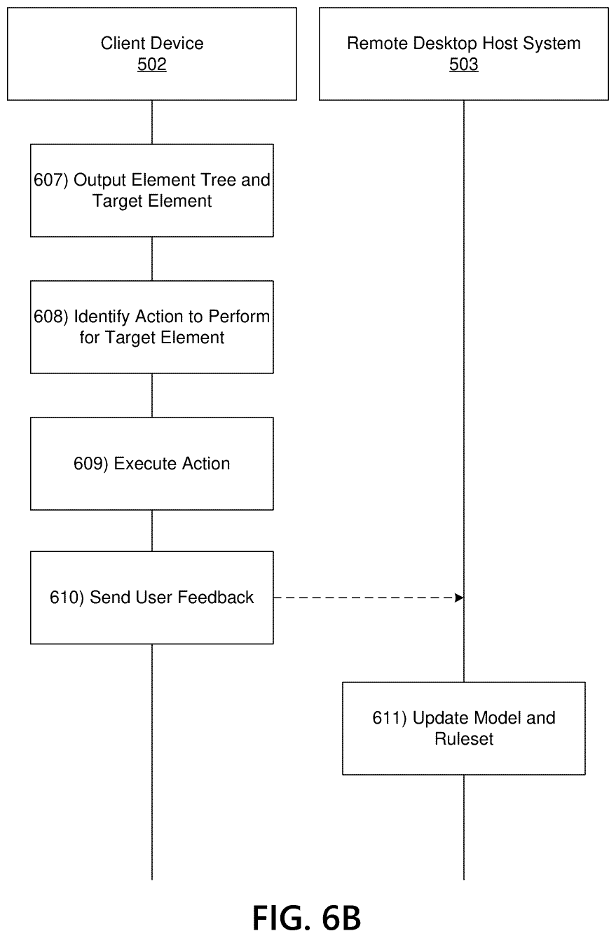

FIGS. 6A-6B depict an illustrative event sequence for using machine learning to enhance virtual desktop interaction in accordance with one or more example embodiments. Referring to FIG. 6A, at step 601, the remote desktop host system 503 or another system/server may train a user interface (UI) element detector model. For example, the remote desktop host system 503 may generate, receive, and/or otherwise obtain a plurality of computer generated screen buffers comprising user interfaces including one or more UI elements, which may, e.g., be used to train a machine learning model to identify UI elements and their corresponding location information (e.g., location within the corresponding interface). More specifically, to train the UI element detector model, the remote desktop host system 503 may input the computer generated screen buffers into a you only look once (YOLO) object detection model, which may, e.g., configure the YOLO object detection model to distinguish UI elements.

The YOLO model may be a real time object detection model, designed to be both fast and accurate. The model architecture may divide input images (e.g., screen buffer images) into an S×S grid, where each grid cell may be responsible for predicting bounding boxes and class probabilities for objects within that cell. YOLO may use a single convolutional neural network (CNN) to directly predict multiple bounding boxes and associated class probabilities in one forward pass through the network. This may allow the model to process images at a high speed while maintaining high accuracy, making it suitable for real time applications.

At its core, YOLO may consist of a series of convolutional layers that may extract spatial features form the input image, followed by fully connected layers that may predict bounding box coordinates, sizes, and confidence scores for the presence of objects. Each bounding box prediction may include a confidence score, which may reflect the accuracy of the predicted bounding box and the likelihood that it may contain an object.

YOLO's architecture may be designed to balance the trade off between speed and accuracy, using techniques like anchor boxes and non-maximum suppression to improve detection performance, particularly for overlapping or closely packed objects.

In the UI element detector model, the YOLO model may be optimized to detect UI elements on a desktop screen through several targeted modifications to the original architecture. Given the generally smaller and less complex nature of UI elements as compared to natural images, it may be important to simply the model's architecture and optimize the loss function and non-maximum suppression.

Custom anchor boxes may be tailored to the specific sizes and shapes of UI components to enhance the UI element detector models ability to detect these elements accurately.

The loss function may be adjusted to better handle class imbalances and small object detection, which may be common in UI elements. To improve the accuracy of detection, optimizing non-maximum suppression (NMS) may be important, particularly for UI elements that may be closely packed together. Output layers may be adjusted to better suit the specific types of UI elements to detect like buttons, icons, text fields, or the like.

Additionally, it may be important to optimize the model for real-time inference on thin client (such as mixed reality, tablets, mobile, or the like) devices, ensuring that the UI element detector model may be both fast and efficient in real time. Techniques like model pruning and quantization may be employed to further enhance performance without sacrificing detection accuracy.

In some instances, leveraging transfer learning from a pre-trained YOLO model may accelerate development by building on already learned features such as edges and corners. Then fine tuning the UI element detector model on the UI specific dataset may allow the UI element detector model to adapt to the nuances of UI elements.

The dataset for fine tuning the UI element detector model may include a combination of existing open source data and a new custom dataset, which may capture a wide range of screenshots that may include various UI elements such as buttons, icons, and text fields, and meticulously labeling them with bounding boxes.

Since UI elements may appear differently depending on screen resolution and scaling settings, additional considerations may be taken into account to handle this during dataset preparation for fine tuning. Additionally, implementing data augmentation techniques, such as rotation, scaling, and occlusion, tailored to UI elements, may be done to help the model generalize across different scenarios.

To ease the model training process, a smaller set of core UI elements may be initially used, and then additional classes may be progressively introduced. In some instances, in addition or as an alternative to the fine-tuned YOLO model described above, an alternative UI element detection model, which may, e.g., be pre-trained, may be used to perform the methods described herein.

At step 602, the remote desktop host system 503 or another system/server may establish a ruleset for a plurality of UI elements, which may, e.g., include correlations between the UI elements and corresponding actions associated with each respective UI element. For example, the ruleset may include, for a given application, a single tap mobile gesture should be mapped to a mouse pointer double click. As another example, the ruleset may include, for a given application, a long tap mobile gesture should be mapped to a mouse pointer right click. As yet another example, the ruleset may include, for a given application or file, if it selected, open the corresponding application or file rather than highlighting it. As yet another example, the ruleset may include, for a given application, a cursor insertion with magnifier overlay rule, mapping a long tap and drag to an automated launch of a magnifier magnifying text underneath coordinates of the user input. As yet another example, the ruleset may include, for a given application, a selection overlay rule to help expand or shrink a selection, which may map the launch of selection overlay with handles based on detecting that the user input is associated with text and that some part of the text is selected. As yet another example, the ruleset may include a mapping between text areas and the launch of special features such as disabled keyboard text predictions, local password manager access, or the like. As yet another example, the ruleset may include, for a given application, a rule indicating that if the corresponding UI element is not draggable, launch quick access to the right click menu based on an input of tap and hold. As yet another example, the ruleset may include, for a given application, a rule indicating that if the corresponding element under the touch is text, provide frequent context menu options such as cut, copy, paste, or the like using a native context menu UI.

Generally speaking, this ruleset may intelligently map touch/virtual gesture inputs to mouse inputs based on underlying UI elements. The above described rules are a non-exhaustive list of example rules, and other similar rules may be implemented without departing from the scope of the disclosure.

At step 603, the remote desktop host system 503 or another system/server may deploy the UI element detector model (trained at step 601) and the ruleset (generated at step 602) to the client device 502. For example, the remote desktop host system 503 or other system/server may deploy the UI element detector model and the ruleset to the client device 502 via a client side remote/virtual desktop application, which may, e.g., store, maintain, and/or otherwise apply the UI element detector model and ruleset upon establishing remote desktop sessions. Although illustrated as hosted by the remote desktop host system 503, the UI element detector model and/or ruleset may be stored, maintained, or otherwise applied by another server, or embedded within the client side remote/virtual desktop application.

At step 604, the client device 502 may establish a remote desktop session with the remote desktop host system 503. For example, the client device 502 may use the client side remote/virtual desktop application to initiate a remote desktop and/or other virtual desktop session, which may, e.g., be hosted and/or otherwise supported by the remote desktop host system 503.

At step 605, the client device 502 may receive user input. For example, the client device 502 may receive a touch input (e.g., single tap, long tap, or the like), gesture input (e.g., swipe, drag, or the like), eye tracking input (e.g., from an eye tracking sensor), pencil input, stylus input, or the like. In some instances, this user input may be received locally at the client device 502 during the remote desktop session established at step 604. In some instances, the user input may be detected after the user interface tree hierarchy has been generated, the screen buffer has been rearranged, or the like, which are described below at step 607.

At step 606, the client device 502 may use the virtual/remote desktop application to capture a screen buffer of a current user interface displayed during the remote desktop session (e.g., being displayed at the time of the receipt of the user input). In some instances, this screen buffer may include the UI elements.

It should be understood that the steps illustrated in FIG. 6B may be performed subsequently after the steps illustrated in FIG. 6A. For example, after step 606 of FIG. 6A, the client device 502 may proceed to step 607 of FIG. 6B. Referring to FIG. 6B, at step 607, the client device 502 may input the screen buffer, captured at step 606, into the UI element detector model to output UI elements which may be used construct UI element tree. For example, thin clients, such as client device 502, may use provided machine learning frameworks to load the fine tuned UI element detector model, and to perform inference, which may, e.g., occur at roughly forty frames per second (FPS). For example, as described above, spatial features may be extracted from the input screen buffer, along with fully connected layers that may use custom anchor boxes tailored to the specific sizes and shapes of UI components to enhance the UI element detector models ability to detect these UI elements accordingly. As described above, a loss function may be used to handle class imbalances and perform small object detection. Furthermore, output layers may be used to detect specific types of UI elements like buttons, icons, text fields, or the like.

Results of the inference may be filtered based on confidence scores and known classes to avoid unwanted predictions. Using the list of UI elements identified and their coordinates, a UI element tree may be constructed with elements grouped based on encompassing anchor boxes. For example, a taskbar UI element's anchor box may have multiple child elements whose boxes are within the taskbar element's rectangle. This tree may either be created from each frame rendered on the screen, or the tree may be progressively updated based on the delta between frames. For example, the UI element tree may indicate coordinates, on the UI, of a plurality of UI elements, which may, e.g., include a first set of user interface elements on a taskbar of the user interface and a second set of user interface elements located on a remaining portion of the UI. In some instances, these user interface elements may be grouped based on a parent child hierarchy. In some instances, an accessibility component of the UI element detector model and/or the client side virtual/remote desktop application may construct a list of accessible elements, using the UI element tree, and may sort the elements by coordinates from top left of the screen to the bottom right of the screen. In these instances, each accessible element may have an anchor box, type, label and description (which may e.g., be obtained via a text detection mechanism). In some instances, at least a portion of the screen buffer may be rearranged based on a frame delta, points of user interest (e.g., identified based on one or more of: the user input, a mouser pointer location, an eye focus, portions of the user interface accessed more than a threshold amount of times, or the like).

In some instances, the UI element detector model and/or the client side virtual/remote desktop application may include a touch target predictor component, which may use the UI element tree to accurately map the user input (e.g., based on coordinates associated with the user input) to potential and close by UI elements. For example, a browser application may be running inside a virtual/remote desktop instance, and if a user tries to tap on a new tab button, a tap gesture might not be as accurate as a mouse click. Accordingly, this component may predict the nearest UI element(s) (e.g., a target element, which the user was likely attempting to interact with) corresponding to the coordinates of the user input, and may adjust these coordinates accordingly before sending to the virtual/remote desktop application. This touch target predictor component may also understand the user touch precision over a period of time and may optimize for future touches. For example, the difference between the original coordinates of the user input and the adjusted coordinates (e.g., corresponding to the target element) may be used to understand user touch accuracy.

Additionally or alternatively, the UI element detector model and/or the client side virtual/remote desktop application may use a spatial interaction enhancer component to place a transparent overlay at each identified UI rectangle. These overlays may be actively updated based on changes in the UI element tree. The overlay may enable eye tracking hover effects and virtual touch focus highlights to be visible when the user focuses on a UI element (e.g., based on sensor input from an eye tracking sensor). For example, when the finger tap gesture is performed on a focused element, this spatial interaction enhancer component may convert the overlay rectangle event to the underlying UI element coordinates to identify the target element.

As a result, using one or more of these techniques, the target element (including an element type) may be output by the UI element detector model.

At step 608, a gesture mapper component of the virtual/remote desktop application may be used to map the user input to a mouse pointer gesture in the context of the specific UI element type of the target element. For example, the gesture mapper component may access the ruleset, generated at step 602, and may apply the ruleset to the coordinates of the user input and the UI element tree (generated at step 606), to intelligently map touch/virtual gesture inputs associated with the user input to actions (e.g., mouse inputs based on the target UI element, or the like). For example, given the application icon as a UI element type and single tap mobile gesture, the map may return the mouse pointer double click as the action. As another example, given the application icon as a UI element type and long tap mobile gesture, the map may return the mouse pointer right click as the action.

Additionally or alternatively, a text interaction enhancer component of the virtual/remote desktop application may use the target element coordinates and the UI element tree, identified at step 606, to identify if the target element coordinates match a text area rectangle. If there is a match, the text interaction enhancer component may identify that the target element supports touch-based text interaction gestures, such as cursor insertion with magnifier overlay, selection overlay, or the like as actions. For example, in cursor insertion with magnifier overlay, if the user input corresponds to a long tap and drag on the identified text rectangle, the identified action may be to automatically launch a magnifier that magnifies the text underneath the coordinates of the user input. With regard to selection overlay, to help expand or shrink a selection, a selection overlay with handles may be placed once the component identifies that the coordinates of the user input correspond to text, and some part of the text may be selected.

Additionally or alternatively, a contextual input area handler component of the virtual/remote desktop application may use the coordinates of the user input and the UI element tree (identified at step 606) to detect if the target element corresponds to a text area. If a text area is detected, special features/actions such as disabled keyboard text predictions, local password manager access, and/or other features may be identified for the target element.

Additionally or alternatively, a contextual menu provider component of the virtual/remote desktop application may use the coordinates of the user input and the UI element tree (identified at step 606) to identify frequently used context menu options using the native UI. For example, if the target element is not draggable, the contextual menu provider component may identify that quick access to the right click menu may be provided when the user input comprises a tap and hold input. As another example, if the target element is text, frequency context menu options like cut, copy, or paste may be provided using the native context menu UI.

Once the action is (or actions are) identified, they may be communicated to the virtual/remote desktop application.

At step 609, the client device 502 may execute the identified action with regard to the target element. For example, the client device 502 may use the virtual/remote desktop application to execute or otherwise initiate a mouse click action (e.g., mouse pointer double click, mouse pointer right click, mouse pointer left click, or the like), cursor insertion with magnifier overlay, selection overlay, special features (e.g., disabled keyboard text predictions, local password manager access, or the like), a right click menu, frequency context menu options (e.g., cut, copy, paste, or the like), and/or other actions.

At step 610, the client device 502 may collect feedback from the user with regard to the target element, identified action, or otherwise. For example, the client device 502 may detect whether a user input to select a different element is received (which may, e.g., indicate that the target element was incorrectly identified by the model). Additionally or alternatively, the client device 502 may detect whether additional user input triggering an alternative action is received (which may, e.g., indicate that the mapping between the user input and the target action was incorrect). The client device 502 may send this feedback to the remote desktop host system 503.

At step 611, the remote desktop host system 503 and/or other system/server may receive the feedback sent at step 610, and may adjust the UI element detector model and/or ruleset accordingly so as to dynamically and continuously improve the performance of the UI element detector model in identifying target UI elements and/or of the ruleset in accurately identifying actions to perform on the target UI elements based on a given user input. In some instances, the remote desktop host system 503 may refine the UI element detector model and/or ruleset continuously, at a predetermined interval, or periodically (e.g., based on detecting that more than a threshold amount of feedback has been received, or the like). In some instances, the receipt of such feedback and adjustment of the UI element detector model and/or ruleset may be performed by another server and/or locally by the client device 502 (e.g., using the client side virtual/remote desktop application).

A number of technical advantages may be achieved through the above described method. For example, the method may help users to activate UI elements even if their tap gesture on a touch interface is not exactly on top of the UI element. This may be achieved, as is described above, by using a touch target predictor component that may identify UI elements nearest to tap coordinates, thereby improving the virtual/remote desktop user experience in touch interface devices. The UI element detector model may use machine learning to understand UI elements and finetune the touch coordinates accordingly. This solution may be further expanded to provide guided access in UI, such as locally highlighting a UI element's rectangle under touch with overlay.

Additionally, eye tracking and virtual touch focus highlighting may be supported, and virtual touch inputs may be mapped to mouse pointer inputs. For example, the spatial interaction enhancer component may help to deliver UI events with eye tracking, finger tap, and/or other inputs, and may help to provide focus highlight in virtual touch.

Another advantage relates to unusual touch gestures. For example, the gesture mapper component may have knowledge on how to convert a touch interface gesture into a mouse pointer gesture for given coordinates. Based on the kind of element identified, corresponding mouse events may be sent to mimic the native touch interface response. Since it might not be possible for virtual/remote desktop instances to send details about all the different UI elements on the screen, this ML based detection may offer advantages.

Furthermore, this may address challenging text interactions. For example, in contrast to simple mappings between touch and mouse pointer events, this method may provide for text magnification popups for text underneath a touch input. Additionally, this may offer text selection handles, allowing a selection of text to be expanded or shrunk. The text interaction enhancer component may enable detection of text area, and may aid in activating text selection quickly.

In addition, the method may address unreliable automatic keyboard popups and text input types. For example, the contextual input area identifier may efficiently detect text input areas and the types of the input expected in such areas.

Furthermore, the method may address problems with deferred menu access. For example, the contextual menu provider component may help in deciding the event to perform based on the underlying UI element type.

In addition, the method may address missing native accessibility problems, such as toggling the accessibility both in local and remote virtual desktop instances, which may result in conflicting navigation. By using a single accessibility system for both the local and remote virtual desktop instances, these problems may be addressed.

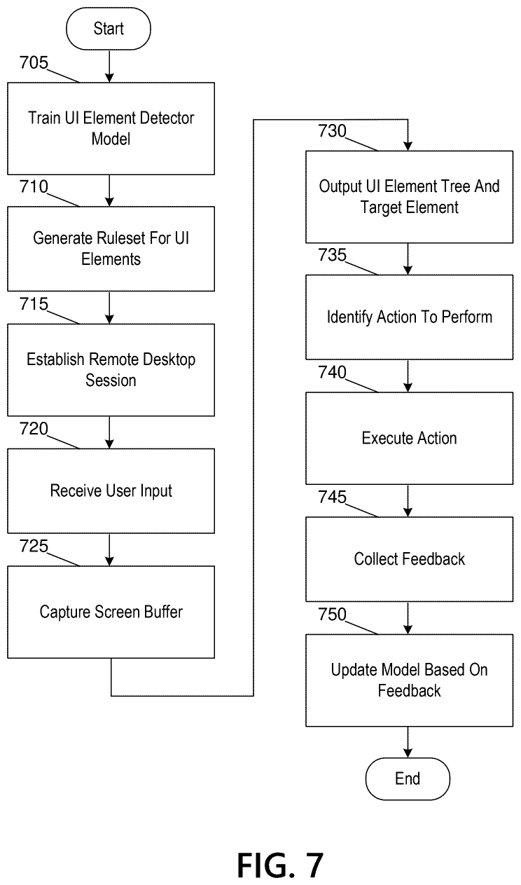

FIG. 7 depicts an illustrative method for using machine learning to enhance virtual desktop interaction in accordance with one or more example embodiments. At step 705, a computing system comprising one or more processors and memory storing computer-executable instructions may train a UI element detector model. At step 710, the computing system may generate a ruleset for UI elements. At step 715, the computing system may establish a remote desktop session. At step 720, the computing system may receive user input via the remote desktop session. At step 725, the computing system may capture a screen buffer during the remote desktop session. At step 730, the computing system may output a UI element tree and target element using the UI element detector model and ruleset. At step 735, the computing system may identify an action to perform on the target element based on the UI element tree. At step 740, the computing system may execute the identified action. At step 745, the computing system may collect feedback on the identified target element and action. At step 750, the computing system may update the UI element detector model and/or ruleset based on the feedback.

The following paragraphs (M1) through (M14) describe examples of methods that may be implemented in accordance with the present disclosure.

(M1) A method comprising capturing, a screen buffer indicating a state of a user interface of a remote desktop session; querying an object detection model using the screen buffer to identify user interface elements displayed on the user interface, wherein the object detection model was trained using computer generated images associated with sample user interfaces and corresponding user interface elements to identify, for a given input interface, a plurality of user interface elements; constructing, based on the identified user interface elements and their coordinates, a user interface tree hierarchy, wherein the user interface tree hierarchy is organized based on element position; arranging at least a portion of the screen buffer based on one or more of: a frame delta, or a point of user interest; detecting, during the remote desktop session, a user input; identifying, based on information associated with the user input and using the user interface tree hierarchy, a target element of the user interface elements; identifying, using a stored ruleset associated with the target element, an action to perform on the target element; and executing, within the remote desktop session, the action on the target element.

(M2) A method may be performed as described in paragraph (M1) wherein the object detection model comprises a fine-tuned you only look once (YOLO) model to detect computer generated user interface elements.

(M3) A method may be performed as described in any one of paragraphs (M1) or (M2), wherein the user input comprises one or more of: a touch input, a gesture input, pencil input, stylus input, or input from an eye tracking sensor.

(M4) A method may be performed as described in any one of paragraphs (M1) through (M3), wherein the user interface tree hierarchy indicates the coordinates, on the user interface, for each of the user interface elements, and wherein the user interface elements are grouped based on parent child hierarchy.

(M5) A method may be performed as described in paragraph (M4), wherein the user interface elements includes a set of user interface elements on a taskbar, and wherein the set of user interface elements are grouped under taskbar.

(M6) A method may be performed as described in any one of paragraphs (M4) or (M5), wherein identifying the target element comprises comparing the coordinates of the user interface elements in the user interface tree hierarchy with coordinates of the user input to identify which of the user interface elements is located nearest to a location of the user input.

(M7) A method may be performed as described in any one of paragraphs (M1) through (M6) wherein the stored ruleset indicates, for each of the user interface elements, one or more actions that are triggered by selection of the target element.

(M8) A method may be performed as described in any one of paragraphs (M1) through (M7), wherein the stored ruleset indicates a rules-based mapping between the user input and mouse inputs, wherein the mouse inputs comprise one of: a double click or a right click.

(M9) A method may be performed as described in any one of paragraphs (M1) through (M8), wherein a client side virtual desktop application, executing at a user device, maintains the object detection model.

(M10) A method may be performed as described in any one of paragraphs (M1) through (M9), further comprising: collecting feedback associated with execution of the action; and updating, based on the feedback, one or more of: the object detection model or the stored ruleset.

(M11) A method may be performed as described in any one of paragraphs (M1) through (M10), wherein identifying the target element using the user interface tree hierarchy comprises: initiating, using the user interface tree hierarchy, a transparent overlay for each identified user interface element.

(M12) A method may be performed as described in paragraph (M11), wherein the user input comprises an eye tracking signal, and wherein the transparent overlay is used to map the eye tracking signal to the target element.

(M13) A method may be performed as described in any one of paragraphs (M1) through (M12), wherein the action comprises magnifying the target element, expanding a selection area, dragging the target element or selecting text.

(M14) A method may be performed as described in any one of paragraphs (M1) through (M13), wherein the point of user interest is identified based on one or more of: the user input, a mouser pointer location, an eye focus, or portions of the user interface accessed more than a threshold amount of times.

The following paragraphs (A1) through (A5) describe examples of apparatuses that may be implemented in accordance with the present disclosure.

(A1) A system comprising one or more processors and memory storing computer executable instructions that, when executed by the one or more processors, cause the computing system to: capture a screen buffer indicating a state of a user interface of a remote desktop session; query an object detection model using the screen buffer to identify user interface elements displayed on the user interface, wherein the object detection model was trained using computer generated images associated with sample user interfaces and corresponding user interface elements to identify, for a given input interface, a plurality of user interface elements; construct, based on the identified user interface elements and their coordinates, a user interface tree hierarchy, wherein the user interface tree hierarchy is organized based on element position; arrange at least a portion of the screen buffer based on one or more of: a frame delta, or a point of user interest; detect, during the remote desktop session, a user input; identify, based on information associated with the user input and using the user interface tree hierarchy, a target element of the user interface elements; identify, using a stored ruleset associated with the target element, an action to perform on the target element; and execute, within the remote desktop session, the action on the target element.

(A2) A system as described in paragraph (A1), wherein the object detection model comprises a fine-tuned you only look once (YOLO) model.

(A3) A system as described in any of paragraphs (A1) or (A2), wherein the user input comprises one or more of: a touch input, a gesture input, pencil input, stylus input, or input from an eye tracking sensor.

(A4) A system as described in any of paragraphs (A1) through (A3), wherein the user interface tree hierarchy indicates the coordinates, on the user interface, for each of the user interface elements, and wherein the user interface elements are grouped based on parent child hierarchy.

(A5) A system as described in paragraph (A4), wherein identifying the target element comprises comparing the coordinates for each of the user interface elements in the user interface tree hierarchy with coordinates of the user input to identify which of the user interface elements is located nearest to a location of the user input.

The following paragraph (CRM1) describes examples of computer-readable media that may be implemented in accordance with the present disclosure.

(CRM1) A non-transitory computer-readable medium storing instructions that, when executed, cause a system to: capture, a screen buffer indicating a state of a user interface of a remote desktop session; query an object detection model using the screen buffer to identify user interface elements displayed on the user interface, wherein the object detection model was trained using computer generated images associated with sample user interfaces and corresponding user interface elements to identify, for a given input interface, a plurality of user interface elements; construct, based on the identified user interface elements and their coordinates, a user interface tree hierarchy, wherein the user interface tree hierarchy is organized based on element position; arrange at least a portion of the screen buffer based on one or more of: a frame delta, or a point of user interest; detect, during the remote desktop session, a user input; identify, based on information associated with the user input and using the user interface tree hierarchy, a target element of the user interface elements; identify, using a stored ruleset associated with the target element, an action to perform on the target element; and execute, within the remote desktop session, the action on the target element.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
capturing, a screen buffer indicating a state of a user interface of a remote desktop session;
querying an object detection model using the screen buffer to identify user interface elements displayed on the user interface, wherein the object detection model was trained using computer generated images associated with sample user interfaces and corresponding user interface elements to identify, for a given input interface, a plurality of user interface elements;
constructing, based on the identified user interface elements and their coordinates, a user interface tree hierarchy, wherein the user interface tree hierarchy is organized based on element position;
arranging at least a portion of the screen buffer based on one or more of: a frame delta, or a point of user interest;
detecting, during the remote desktop session, a user input;
identifying, based on information associated with the user input and using the user interface tree hierarchy, a target element of the user interface elements;
identifying, using a stored ruleset associated with the target element, an action to perform on the target element; and
executing, within the remote desktop session, the action on the target element.

2. The method of claim 1, wherein the object detection model comprises a fine-tuned you only look once (YOLO) model to detect computer generated user interface elements.

3. The method of claim 1, wherein the user input comprises one or more of: a touch input, a gesture input, pencil input, stylus input, or input from an eye tracking sensor.

4. The method of claim 1, wherein the user interface tree hierarchy indicates the coordinates, on the user interface, for each of the user interface elements, and wherein the user interface elements are grouped based on parent child hierarchy.

5. The method of claim 4, wherein the user interface elements includes a set of user interface elements on a taskbar, and wherein the set of user interface elements are grouped under taskbar.

6. The method of claim 4, wherein identifying the target element comprises comparing the coordinates of the user interface elements in the user interface tree hierarchy with coordinates of the user input to identify which of the user interface elements is located nearest to a location of the user input.

7. The method of claim 1, wherein the stored ruleset indicates, for each of the user interface elements, one or more actions that are triggered by selection of the target element.

8. The method of claim 1, wherein the stored ruleset indicates a rules-based mapping between the user input and mouse inputs, wherein the mouse inputs comprise one of: a double click or a right click.

9. The method of claim 1, wherein a client side virtual desktop application, executing at a user device, maintains the object detection model.

10. The method of claim 1, further comprising:
collecting feedback associated with execution of the action; and
updating, based on the feedback, one or more of: the object detection model or the stored ruleset.

11. The method of claim 1, wherein identifying the target element using the user interface tree hierarchy comprises:
initiating, using the user interface tree hierarchy, a transparent overlay for each identified user interface element.

12. The method of claim 11, wherein the user input comprises an eye tracking signal, and wherein the transparent overlay is used to map the eye tracking signal to the target element.

13. The method of claim 1, wherein the action comprises magnifying the target element, expanding a selection area, dragging the target element or selecting text.

14. The method of claim 1, wherein the point of user interest is identified based on one or more of: the user input, a mouser pointer location, an eye focus, or portions of the user interface accessed more than a threshold amount of times.

15. A computing system comprising:
one or more processors;
memory storing computer executable instructions that, when executed by the one or more processors, cause the computing system to:
capture a screen buffer indicating a state of a user interface of a remote desktop session;
query an object detection model using the screen buffer to identify user interface elements displayed on the user interface, wherein the object detection model was trained using computer generated images associated with sample user interfaces and corresponding user interface elements to identify, for a given input interface, a plurality of user interface elements;
construct, based on the identified user interface elements and their coordinates, a user interface tree hierarchy, wherein the user interface tree hierarchy is organized based on element position;
arrange at least a portion of the screen buffer based on one or more of: a frame delta, or a point of user interest;
detect, during the remote desktop session, a user input;
identify, based on information associated with the user input and using the user interface tree hierarchy, a target element of the user interface elements;
identify, using a stored ruleset associated with the target element, an action to perform on the target element; and
execute, within the remote desktop session, the action on the target element.

16. The computing system of claim 15, wherein the object detection model comprises a fine-tuned you only look once (YOLO) model.

17. The computing system of claim 15, wherein the user input comprises one or more of: a touch input, a gesture input, pencil input, stylus input, or input from an eye tracking sensor.

18. The computing system of claim 15, wherein the user interface tree hierarchy indicates the coordinates, on the user interface, for each of the user interface elements, and wherein the user interface elements are grouped based on parent child hierarchy.

19. The computing system of claim 18, wherein identifying the target element comprises comparing the coordinates for each of the user interface elements in the user interface tree hierarchy with coordinates of the user input to identify which of the user interface elements is located nearest to a location of the user input.

20. One or more non-transitory computer-readable media storing instructions that, when executed by a computing system comprising at least one processor, a communication interface, and memory, cause the computing system to:
capture, a screen buffer indicating a state of a user interface of a remote desktop session;
query an object detection model using the screen buffer to identify user interface elements displayed on the user interface, wherein the object detection model was trained using computer generated images associated with sample user interfaces and corresponding user interface elements to identify, for a given input interface, a plurality of user interface elements;
construct, based on the identified user interface elements and their coordinates, a user interface tree hierarchy, wherein the user interface tree hierarchy is organized based on element position;
arrange at least a portion of the screen buffer based on one or more of: a frame delta, or a point of user interest;
detect, during the remote desktop session, a user input;
identify, based on information associated with the user input and using the user interface tree hierarchy, a target element of the user interface elements;
identify, using a stored ruleset associated with the target element, an action to perform on the target element; and
execute, within the remote desktop session, the action on the target element.
